(19) United States
(12) Patent Application Publication
(10) Pub. No.: US 2020/0042216 A1
(43) Pub. Date: Feb. 6, 2020

(54) STORAGE-BASED GRAPH FOR ENABLING COMPUTATION GRAPH OPTIMIZATION

(71) Applicant: ALIBABA GROUP HOLDING LIMITED, George Town (KY)

(72) Inventor: Weifang ZHANG, San Mateo, CA (US)

(21) Appl. No.: 16/054,953

(22) Filed: Aug. 3, 2018

(51) Int. Cl. G06F 3/06; G06F 17/30; G06N 3/063

(52) U.S. Cl. CPC G06F 3/0635; G06F 17/30958; G06N 3/063; G06F 3/0688; G06F 3/0611

(57) ABSTRACT

The present disclosure relates to an apparatus transforming a computation graph. The apparatus comprises a converter configured to convert the computation graph into a storage-based graph having a plurality of nodes and at least one edge representing an operation performed on data flowing between two nodes among the plurality of nodes. Each of the plurality of nodes represents a storage storing data. The apparatus further comprises an optimizer configured to identify at least one processing condition of a processing system executing the computation graph, and to adjust the storage-based graph according to the at least one processing condition.

### BACKGROUND

In machine learning (ML) or deep learning (DL), a neural network may be graphically represented by a computational graph or a data structure comprising nodes and edges organized as a directed acyclic graph (DAG). Nodes represent variables or computation operations, while edges represent data or tensor flowing from one node to another. An incoming edge to a node representing a computation operation is input data consumed by the computation operation, while an outgoing edge from the node represents output data produced by the computation operation. The computation graph typically describes how the data is processed or transformed.

When an ML/DL model is executed on a hardware accelerator, a computation graph of the model is partitioned and mapped to hardware acceleration logics for maximal performance. During execution, the inputs and weights are transferred to on-chip memory space of the accelerator so that these data can be reused as much as possible to minimize time for data transfer. At the same time, the on-chip memory can be also used to store intermediate results from the computation operation to reduce time for data transfers before executing a following computation operation.

Various optimizations are needed to be done on the computation graph to obtain the best performance from the accelerator. The optimizations include scheduling data transfers and following computation operations so that their execution is pipelined as much as possible; and assigning on-chip memory when mapping the computation graph so that the on-chip memory can be reused during the execution without accessing external memory. It is challenging to determine how to efficiently perform these optimizations on the existing computation graphs. It is also difficult to identify performance bottleneck and/or optimal number of storages needed during hardware design based on the existing computation graphs.

### SUMMARY

Embodiments of the present disclosure provide an apparatus for transforming a computation graph. The apparatus comprises a converter configured to convert the computation graph into a storage-based graph having a plurality of nodes and at least one edge representing an operation performed on data flowing between two nodes among the plurality of nodes. Each of the plurality of nodes represents a data storage. The apparatus further comprises an optimizer configured to identify at least one processing condition of a processing system executing the computation graph, and to adjust the storage-based graph according to the at least one processing condition.

Embodiments of the present disclosure also provide a method for transforming a computation graph. The method comprises converting the computation graph into a storage-based graph having a plurality of nodes and at least one edge representing an operation performed on data flowing between two nodes among the plurality of nodes. Each of the plurality of nodes represents a data storage. The method further comprises identifying at least one processing condition of a processing system executing the computation graph, adjusting the storage-based graph according to the at least one processing condition.

Embodiments of the present disclosure also provide a non-transitory computer readable medium that stores a set of instructions that is executable by at least one processor of a computing device to cause the computing device to perform a method for transforming a computation graph. The method comprises converting the computation graph into a storage-based graph having a plurality of nodes and at least one edge representing an operation performed on data flowing between two nodes among the plurality of nodes. Each of the plurality of nodes representing a data storage. The method further comprises identifying at least one processing condition of a processing system executing the computation graph and adjusting the storage-based graph according to the at least one processing condition.

The storage-based graph can include at least one virtual node indicating data availability. A plurality of storages can be uniquely assigned to the plurality of nodes in the storage-based graph. The plurality of storages can be logical storages. The optimizer can be further configured to identify at least one global storage causing latency in a critical path of the storage-based graph. The at least one global storage among the plurality of storages assigned to the plurality of nodes can be replaced with at least one on-chip storage in the adjusted storage-based graph. One on-chip storage can be assigned to at least two nodes of the plurality of nodes in the adjusted storage-based graph. At least one redundant path having longer latency than an alternate path can be eliminated in the adjusted storage-based graph. The optimizer is further configured to update the adjusted storage-based graph by associating each edge of the at least one edge with a corresponding operation cost. The at least one processing condition is selected from a group consisting of available on-chip storage resources of the processing system and storage allocation information for a certain operation.

### BRIEF DESCRIPTION OF THE DRAWINGS

FIG. 1 illustrates an exemplary neural network processing unit (NPU) architecture, consistent with embodiments of the present disclosure.

FIG. 2 illustrates an example of a typical computation graph representation.

FIG. 3 illustrates an exemplary method for transforming a computation graph, consistent with embodiments of the present disclosure.

FIG. 4 illustrates a block diagram of exemplary components of a system including an apparatus for transforming a computation graph, consistent with embodiments of the present disclosure.

FIG. 5 illustrates a first example for transforming the computation graph of FIG. 2 to identify optimal storage allocation, consistent with embodiments of the present disclosure.

FIG. 6 illustrates an example for updating the transformed computation graph of FIG. 5 to associate each edge with an operation cost, consistent with embodiments of the present disclosure.

FIG. 7 illustrates a second example for transforming the computation graph of FIG. 2 to identify optimal storage allocation when the number of on-chip storages is limited, consistent with embodiments of the present disclosure.

FIG. 8A illustrates an example of hardware design choices for the computation graph of FIG. 2.

FIG. 8B illustrates a third example for transforming the computation graph of FIG. 2 to determine whether the design choices illustrated in FIG. 8A are desirable, consistent with embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

The disclosed embodiments provide apparatuses and methods for transforming a computation graph. The disclosed embodiments can resolve aforementioned issues by introducing a kernel flow graph (KFG) generated from the conventional computation graphs. KFG enables efficient optimizations on machine learning graphs to maximize accelerator's performance. KFG, which is a storage-based graph, helps identifying what causes performance bottlenecks based on the storing and loading of data onto certain types of storages. KFG also helps with identifying whether additional storages should be added to the accelerator, or whether certain storages are superfluous in the existing accelerator.

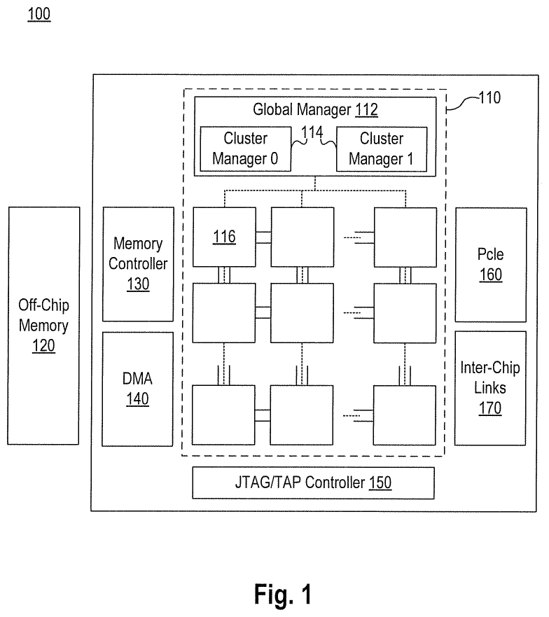

FIG. 1 illustrates an exemplary neural network processing unit (NPU) architecture 100. NPU architecture 100 can include an on-chip communication system 110, an off-chip memory 120, a memory controller 130, a direct memory access (DMA) unit 140, a Joint Test Action Group (JTAG)/Test Access End (TAP) controller 150, a peripheral component interconnect express (PCIe) interface 160, inter-chip links 170, and the like. It is appreciated that on-chip communication system 110 can perform algorithmic operations based on communicated data.

On-chip communication system 110 can include a global manager 112 and a plurality of tiles 116. Global manager 112 can include one or more cluster managers 114 configured to coordinate with one or more tiles 116. Each cluster manager 114 can be associated with an array of tiles 116 that provide synapse/neuron circuitry for the neural network. For example, the top layer of tiles of FIG. 1 may provide circuitry representing an input layer to neural network, while the second layer of tiles may provide circuitry representing a hidden layer of the neural network. As shown in FIG. 1, global manager 112 can include two cluster managers 114 configured to coordinate with two arrays of tiles 116. Tiles 116 can include SIMD (Single Instruction Multiple Data) architecture including one or more multipliers, adders, multiply-accumulators and corresponding memory and can be configured to perform an operation (e.g., one or more algorithmic calculations) on the communicated data under the control of global manager 112.

Off-chip memory 120 can include read-only memory (ROM), erasable programmable read-only memory (EPROM) or the like. Off-chip memory 120 can be configured to store a large amount of data with slower access speed, compared to the on-chip memory integrated within one or more processor.

Memory controller 130 can read, write, or refresh one or more memory devices. The memory devices can include on-chip memory and off-chip memory 120. For example, the memory device can be implemented as any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, or a magnetic or optical disk.

In this specification, a global buffer is associated with a memory region of the off-chip memory 120, and an on-chip buffer is associated with a memory region of the on-chip memory. A buffer is a region of a physical memory storage used to store data. The buffer can be a physical buffer implemented in a fixed memory location in hardware, or a virtual buffer implemented in software and mapped to a location in the physical memory. Storage can be any component where data is stored and accessed including memory and buffer. In this specification, the term “storage” may refer a portion of a storage device as well as the entire storage device.

DMA unit 140 can generate memory addresses and initiate memory read or write cycles. DMA unit 140 can contain several hardware registers that can be written and read by the one or more processors. The registers can include a memory address register, a byte-count register, and one or more control registers. These registers can specify some combination of the source, the destination, the direction of the transfer (reading from the input/output (I/O) device or writing to the I/O device), the size of the transfer unit, and/or the number of bytes to transfer in one burst.

JTAG/TAP controller 150 can specify a dedicated debug port implementing a serial communications interface (e.g., a JTAG interface) for low-overhead access without requiring direct external access to the system address and data buses. The JTAG/TAP controller 150 can also specify an on-chip test access interface (e.g., a TAP interface) that implements a protocol to access a set of test registers that present chip logic levels and device capabilities of various parts.

Peripheral interface 160 can support full-duplex communication between any two endpoints, with no inherent limitation on concurrent access across multiple endpoints.

Inter-chip links 170 can connect all the internal components of NPU architecture 100, such as on-chip communication system 110, off-chip memory 120, memory controller 130, DMA unit 140, JTAG/TAP controller 150, and PCIe interface 160 to each other.

As stated above, NPU architecture 100 may incorporates SIMD architecture. While the disclosed embodiments are described with respect to NPU architecture 100 for accelerating some applications such as deep learning, it is appreciated that the embodiments could be applied to, for example, GPU (Graphics Processing Unit), FPGA (Field Programmable Gate Array), CPU (Central Processing Unit) with vector processing ability, or neural network accelerators for deep learning. The SIMD or vector architecture is commonly used to support computing devices with data parallelism, such as graphics processing and deep learning. The SIMD architecture can include multiple processing elements, wherein each of the processing elements can perform the same operation on multiple data points simultaneously.

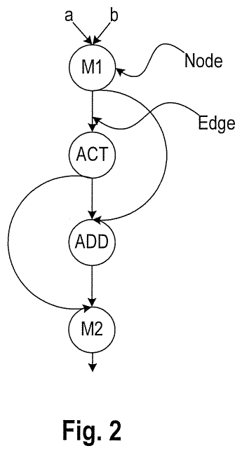

FIG. 2 illustrates an example of a typical computation graph representation. In machine learning (ML) or deep learning (DL), a neural network may be graphically represented by a computational graph. A typical computation graph comprises nodes and edges organized as a directed acyclic graph (DAG). Nodes represent variables or computation operations, while edges represent data or tensor flowing from one node to another. The direction of an edge indicates data dependency between two computations represented by two different nodes. An incoming edge to a node representing a computation operation is input data consumed by the computation operation, while an outgoing edge from the node represents output data produced by the computation operation. It should be noted that the computation graph of FIG. 2 is explanatory only and not restrictive, and thus embodiments of the present disclosure may generate KFG by using other types of computational graphs if data flow and computation operations are identifiable from the computational graphs.

The computation graph of FIG. 2 includes 4 nodes, each of which represents a computational operation performed on input data on incoming edges: “M1” represents an operation of multiplication, “ACT” represents an operation of activation function, “ADD” represents an operation of addition, and “M2” represents an operation of another multiplication. First multiplication node M1 receives “a” and “b” as inputs and its output is provided to activation and addition nodes ACT and ADD. Activation node ACT receives the output of first multiplication node M1 as an input and its output is provided to the addition and multiplication nodes ADD and M2. Addition node ADD receives the outputs of activation and first multiplication nodes ACT and M1 as inputs and its output is provided to second multiplication node M2. Second multiplication node M2 receives the outputs of activation and addition nodes ACT and ADD. An output of second multiplication node M2 can be a final output of the computation graph when the node M2 is a “root” node. Optionally, the output of second multiplication node M2 can be forwarded to a following node (not shown) when the computation graph of FIG. 2 is a part of a computation graph. In the specification, embodiments of the present disclosure are described assuming the first scenario.

A typical ML/DL model may have thousands or even millions of nodes and hundreds of Mbytes of data. It means that a computation graph representing the typical ML/DL model may be thousands or millions of times larger than the computation graph illustrated in FIG. 2. To accelerate the execution of the ML/DL model, enormous amount of resources such as processing units and storage spaces are necessary. Otherwise, the execution of the ML/DL model will take too much time. Since the resources of an accelerator is limited, it is very important to maximize the usage of the limited resources to improve performance of the accelerator.

Noted from FIG. 2, it is difficult to identify properties from the typical computation graph, which enable various optimizations to improve ML/DL performance or hardware accelerator design. Embodiments of the present disclosure introduce a kernel flow graph (KFG) generated from conventional computational graphs. KFG remedies the shortcomings of the conventional graphs. An apparatus and a method for transforming a computation graph consistent with embodiments of the present disclosure will be described in detail referring the accompanying drawings.

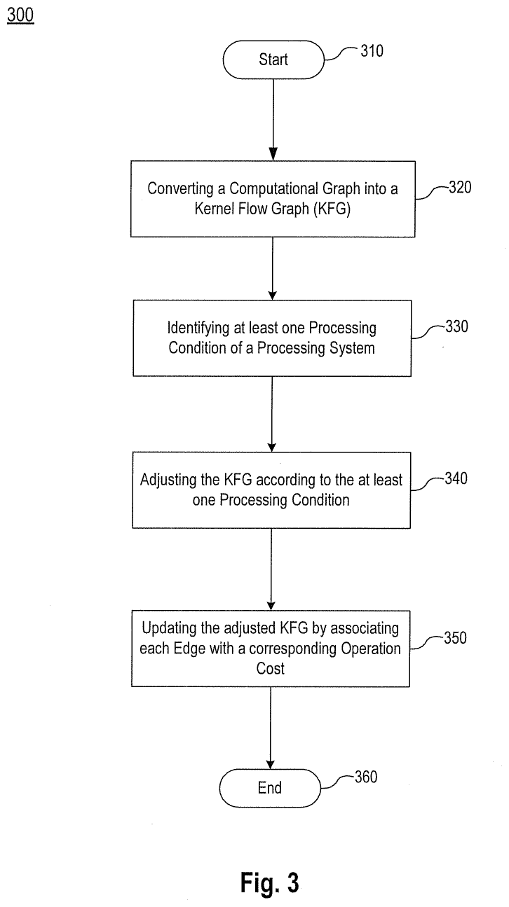

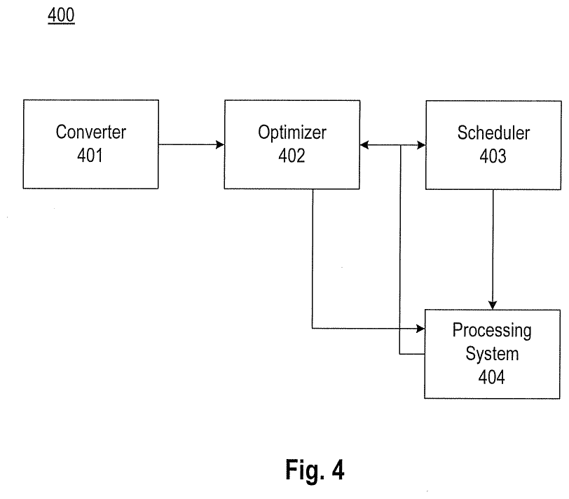

Reference is now made to FIG. 3, which illustrates an exemplary method for transforming a computation graph, consistent with embodiments of the present disclosure. According to embodiments of the present disclosure, the order of the steps can be altered and/or at least one step can be omitted in a method for transforming a computation graph. The method of FIG. 3 may be executed by the apparatus 400 and/or system of FIG. 4. FIG. 4 illustrates a block diagram of exemplary components of a system including an apparatus for transforming a computation graph, consistent with embodiments of the present disclosure. Each step of the method of FIG. 3 is explained with reference to FIG. 4.

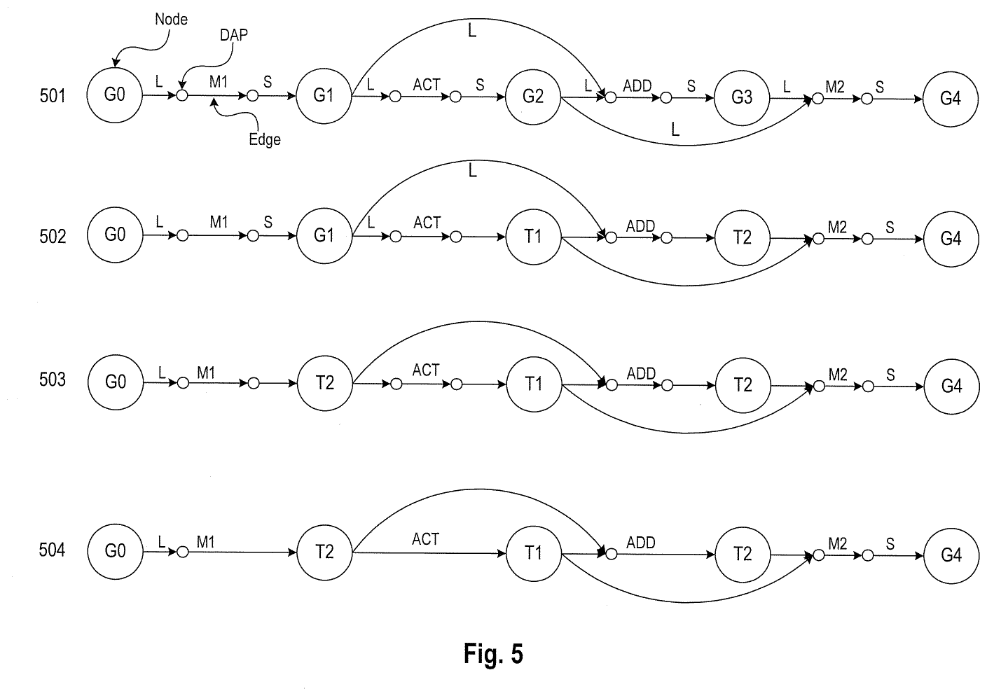

In FIG. 4, the apparatus 400 for transforming a computation graph may be implemented within a system. The apparatus 400 for transforming a computation graph may include converter 401 and optimizer 402, consistent with embodiments of the present disclosure. The scheduler 403 may perform the function of scheduling and resource allocation based on the transformed KFG, consistent with embodiments of the present disclosure. In some embodiments, the system of FIG. 4 may include scheduler 403 and processing system 404 in addition to the apparatus 400 for transforming a computation graph. Referring back to FIG. 3, the method begins at step 310 and continues to step 320, where a kernel flow graph (KFG) is generated based on a computational graph. At step 320, converter 401 generates KFG by converting the computation graph. KFG includes a plurality of nodes and at least one edge representing an operation performed on data flowing between two nodes among the plurality of nodes. Each of the plurality of nodes represents a data storage. Unlike the conventional computation graph, KFG uses a node to represent a data storage and an edge to represent an operation performed on data flowing from one storage node to another storage node. KFG will be explained in detail with reference to FIG. 5.

Next, at step 330, at least one processing condition of processing system 404 is identified. Here, the processing system 404 may have the NPU architecture 100 of FIG. 1. The at least one processing condition may be selected from a group consisting of available on-chip storage resources of the processing system 404 and storage allocation information for a certain operation. The available on-chip storage resources of the processing system 404 may include the number of the on-chip storage, which the current application can use for execution. Optionally, the available on-chip storage resources of the processing system 404 may include the number of the on-chip storage included in the processing system 404. The storage allocation information may include constraints regarding which data should be stored in a certain memory space.

At step 330, optimizer 402 identifies the at least one processing condition. Optionally, the at least one processing condition may be received from the processing system 404. The at least one processing condition may be known to the apparatus for transforming the computation graph according to the embodiments. The at least one processing condition may also be stored in a memory device readily accessible by the apparatus for transforming the computation graph. Optimizer 402 can receive the information regarding the at least one processing condition from the processing system 404 as an example.

At step 340, KFG is adjusted according to the at least one processing condition identified at step 330. The adjustment may comprise replacing at least one off-chip storage among a plurality of storages assigned to a plurality of nodes in KFG with at least one on-chip storage. The adjustment may comprise eliminating at least one redundant path having longer latency than an alternate path in KFG. In some embodiments, optimizer 402 of FIG. 4 adjusts the KFG according to the at least one processing condition of the processing system 404.

At step 350, KFG is updated by associating each edge of KFG with a corresponding operation cost. Optimizer 402 is further configured to update the KFG such that each edge indicates a corresponding operation cost. The operation cost can be represented by a computational operation, transfer operation, or functional operation. Next, at step 360, the method for transforming a computation graph ends. According to embodiments of the present disclosure, scheduler 403 may perform scheduling to pipeline data transfers and computations when the processing system 404 executes the ML/DL model based on the transformed KFG. Scheduler 403 may also perform allocation of the resources of the processing system 404 to execute the model.

Embodiments of the present disclosure introduce KFG generated from a computational graph of a neural network model. KFG enables identifying optimal storage assignment during optimization. FIG. 5 illustrates a first example for transforming the computation graph of FIG. 2 to identify optimal storage allocation, consistent with embodiments of the present disclosure. The first example is illustrated using states 501-504.

In state 501, an initial state of KFG derived from the computation graph of FIG. 2 is shown. A node in KFG represents a data storage and an edge represents an operation performed on data flowing through the edge. The operation may comprise a computational operation, functional operation, data transfer and transformation performed on data. Herein after, embodiments are explained using a buffer as an example of a data storage for an illustration purpose. As shown in FIG. 5, a plurality of data storages are uniquely allocated to the plurality of nodes in KFG at state 501 to prevent overwriting in the same data storage. That is, each node is assigned with its own data buffer such that data buffers G0 to G4 are respectively assigned to each of the nodes. This allocation is referred to as single storage allocation (SSA). “G” at the node represents a global buffer which is an off-chip buffer. The fact that the index for the global buffer is increased from 0 to 4 at state 501 shows that the buffers are uniquely assigned to the nodes. Although global buffers are assigned to all the nodes in state 501 of FIG. 5, on-chip buffers can be assigned to all or some nodes for an initial KFG.

The data buffers in KFG at state 501 are considered as logical buffers, rather than physical buffers. By using logical storages instead of physical storages, it is possible to use as many storages as needed during the transformation. After the transformation is completed, the logical storages can be mapped to physical storages and the logical storages can be eliminated. Optionally, when a storage allocation for a certain node is fixed during transformation, the logical storage for the node can be mapped to a physical storage and the logical storage can be eliminated. SSA technique using logical storages provides the benefit of simplification during the transformation and optimization in that the logical storages can be mapped to physical storages when the storage allocation or optimization is fixed.

The state 501 in FIG. 5 shows that the data is loaded from a global buffer G0, and thus the edge starting from the buffer G0 is labelled “L (load)” as an operation for the edge. KFG may include at least one virtual node indicating data availability, which is called data available point (DAP). DAP is indicated as a small node at the state 501 in FIG. 5. DAP also conveniently represents a joint point of two edges in KFG. After the data is loaded (here, the data includes “a” and “b” referring to FIG. 2) to DAP at the starting point of a first multiplication edge M1 corresponding to the first multiplication node M1 of FIG. 2, the first multiplication operation M1 is performed on the data. When the result of the first multiplication operation M1 is available at DAP at the ending point of the first multiplication edge M1, an edge starting from the DAP at the ending point of the first multiplication edge M1 is labelled “S (store),” which results in the result of the first multiplication operation M1 being stored at a global buffer G1. Similarly, the rest of nodes and edges are constructed based on the computation graph of FIG. 2, and the resultant KFG is shown as state 501 of FIG. 5. It is noted that the KFG at state 501 of FIG. 5 represents the same neural network model as the computation graph of FIG. 2.

When constructing KFG from the original computation graph, a node representing a computational operation in the original computation graph is converted to an edge, and new nodes are introduced at the front side and the end side of the edge to represent where input data and output data for the computational operation of the edge are stored. KFG may further include DAP at a position between the new node and the edge representing the computational operation to show data availability. It is also noted from FIG. 5 that a direction of an edge in KFG indicates the same independency as in the original computation graph of FIG. 2. It should be noted that KFG construction from a conventional computation graph has a linear complexity of the computation graph.

To maximize the accelerator's performance, the critical path in a computation graph is transformed during scheduling and optimizing to minimize the execution time for the critical path. The transformation uses a traversal of the computation graph to form the KFG to minimize execution time and to maximize the accelerator's performance. Using the computation graph of FIG. 2 as an example, in FIG. 5, a KFG can start with initial critical path having the longest execution time (state 501) from the first node (G0) to the last node (G4): L-m1-S-L-act-S-L-add-S-L-m2-S, and adjust the critical path to minimize the execution time (e.g., state 503 or 504).

Processes to identify optimal storage allocation and/or assignment will be explained by referring to states 502 and 503 of FIG. 5. States from 501 to 503 show steps to discover optimal storage assignment. The process may start by examining the KFG of state 501 backwards. It is shown in KFG at state 501 that data is initially loaded from a global buffer G0 and lastly stored in a global buffer G4. The final output of the KFG is stored in the global memory, and thus the global buffer G4 is not reassigned and remains unchanged in state 502. At DAP located at the starting point of a second multiplication edge M2, there are two incoming edges which represent two inputs for the second multiplication operation M2. The second multiplication operation M2 is performed on the two inputs and it will be beneficial to change the global buffers G2 and G3 to on-chip buffers to store the intermediate results, i.e., the two inputs. That is, the two inputs are reused during the execution and thus changing the global buffer G2 and G3 to on-chip buffers enables reducing the transfer time of the data. Since the two inputs, loaded from G2 and G3, should be live at the same time, the global buffers G2 and G3 are reassigned to two different on-chip buffers T1 and T2 in the state 502. If the global buffers G2 and G3 are changed to the same on-chip buffer T1/T2, the two inputs will be overwritten with each other and cannot be valid for the second multiplication operation M2.

The processes may continue to examine the KFG of 502 backwards. Similarly, at the starting DAP of an addition edge ADD, there are two inputs as well. Since the global buffer G2 is already changed to the on-chip buffer T1, the global buffer G1 can be changed to an on-chip buffer to reduce data transfer time. At the state 503, it is noted that the global buffer G1 is reassigned to the on-chip buffer T2 instead of introducing a new on-chip buffer such as T3. The reason the on-chip buffer T2 can be recycled is that it is possible to store corresponding data at the second and fourth nodes without overwriting. That is, the on-chip buffer T2 is dead (no longer needed) when applying liveness analysis on the used buffers. Here, live range analysis can be used to identify if a variable is dead or live at certain period of the program execution. In this way, it is possible to obtain the optimal number of on-chip buffers (here, two buffers are needed) required to execute this KFG without suffering the heavy cost of global data transfer. By generating and transforming KFG, it is also possible to identify optimal storage allocation for the best performance of the processing system. In some embodiments, the global buffer G1 can be replaced with a new on-chip buffer T3 at the state 503, for example, when the processing system has enough on-chip buffers.

It is noted that load and store operations L and S from/to the on-chip buffer T1, T2, and T3 are removed from the corresponding edges of the KFG at states 502 and 503 by assuming that the data transfer time to load/store from/to the on-chip buffer is almost zero. This assumption is based on that data transfer time from/to an on-chip storage is much smaller than that of an off-chip storage (here, a global buffer). The KFG at state 504 shows the simplified version of the KFG at state 503 for illustration purpose by removing some DAPs located at the front side or end side of the edge of which load or store operation L or S is removed at state 503 of FIG. 5. Here, DAPs at the starting point of the addition edge ADD and at the starting point of the second multiplication edge M2 are not removed because the DAPs are the points receiving two inputs from different nodes.

In FIG. 5, the state 501 shows an example of a generated KFG from a conventional computation graph of FIG. 2, and the states 502 to 504 show examples of adjusting KFG.

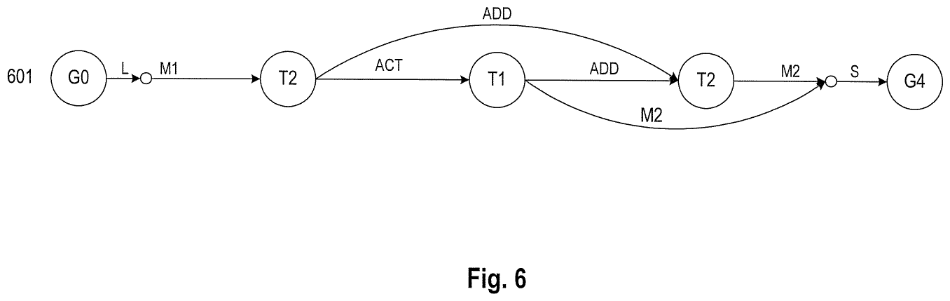

KFG can also enable operation scheduling to pipeline data transfers and computations for further improvement on the accelerator performance. Execution time for each operation such as computation, transformation and data transfer may be known for a certain processing system (e.g., FPGA) or may be calculated based on the statistics, according to embodiments of the present disclosure. The execution time for an operation may represent an operation cost for the operation. FIG. 6 illustrates an example for updating the transformed computation graph of FIG. 5 to associate each edge with an operation cost, consistent with embodiments of the present disclosure. The updated KFG of FIG. 6 may be obtained from the state 504 of FIG. 5 by back propagating the costs. Here, DAPs at the starting point of the addition edge ADD and at the starting point of the second multiplication edge M2 at the state 504 of FIG. 5 are removed in FIG. 6. It is noted that the upper edge from the on-chip buffer T2 to the DAP at the starting point of the addition edge ADD of the state 504 is replaced with an edge from the on-chip buffer T2 (second node from the left of the state 601) to the on-chip buffer T2 (fourth node from the left of the state 601) and is labelled as ADD in the state 601. Further the two edges between the on-chip buffers T1 and T2 (third and fourth nodes from the left of the state 6010) of the state 504 is replaced with one edge labelled as ADD in the state 601. In the state 601, it is readily known that the addition operation ADD is performed on inputs loaded from the on-chip buffers T2 (second node) and T1 (third node) and its output is provided to the on-chip buffer T2 (fourth node). Similarly, it is noted that the lower edge from the on-chip buffer T1 to the DAP at the starting point of the second multiplication edge M2 of the state 504 is replaced with an edge from the on-chip buffer T1 to the DAP at the ending point of the second multiplication edge M2 and is labelled as M2 in the state 601. Further the two edges between the on-chip buffer T2 and the DAP at the beginning point of the second multiplication edge M2 of the state 504 is replaced with one edge labelled as M2 in the state 601. In the state 601, it is readily known that the second multiplication operation M2 is performed on inputs loaded from the on-chip buffers T1 and T2 (fourth node) and its output is provided to the global buffer G4.

As shown in the updated KFG of FIG. 6, each edge of the KFG is associated with a corresponding operation cost. So, pipelining data transfers and computations is readily enabled using the updated KFG of FIG. 6. It is also noted that even if the cost of a certain operation is not known, scheduling of the graph to pipeline can still be achieved with the estimation of the operation cost. Here, since data loading and storing are explicitly labelled as operations, the data transfers can be treated equally as regular computational operations when scheduling. As a result, scheduler 404 may schedule the data transfers according to a typical topological scheduling policy. It should be noted that the updating of KFG described referring to FIG. 6 can also be applied to other embodiments of the present disclosure.

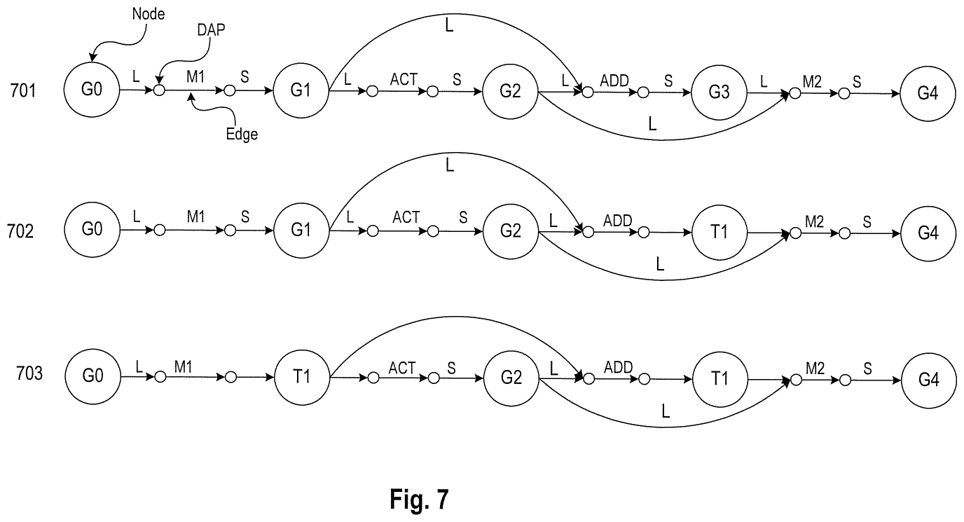

FIG. 7 illustrates a second example for transforming the computation graph of FIG. 2 to identify optimal storage allocation when the number of on-chip storages is limited, consistent with embodiments of the present disclosure. FIG. 7 illustrates an example for transforming the computation graph to identify an optimal buffer assignment when there is a constraint that only one physical on-chip buffer is allowed. KFG at a state 701 of FIG. 7 is same with the KFG at the state 501 of FIG. 5.

Processes to identify optimal storage allocation and/or assignment when only one physical on-chip buffer is allowed will be explained by referring to states 702 and 703 of FIG. 7. The processes may start by examining the KFG of 701 backwards. It is shown that the global buffer G3 is replaced with on-chip buffer T1 at the state 702 and the global buffer G1 is replaced with the on-chip buffer T1 at the state 703. As described referring to FIG. 5, the first global buffer G0 and last global buffer G4 are not replaced with the on-chip buffer since the first inputs are loaded from a global buffer and the last outputs are stored back to a global buffer. At a step changing from the state 701 to the state 702, there are options to pick any one of global buffers G2 and G3 in the critical path to replace with the on-chip buffer T1. The reason of choosing G3 for the replacement is that the on-chip buffer T1 cannot be recycled if G2 is replaced with the on-chip buffer T1. To avoid overwriting in the buffer, G1 and G2 cannot be replaced with the same on-chip buffer, and G2 and G3 cannot be replaced with the same on-chip buffer. In the KFG of FIG. 7, the buffers at the second and third nodes should be alive at the same time and the buffers at the third and fourth nodes should be alive at the same time. In this way, it is determined that the on-chip buffer T1 is recycled for the second and fourth nodes. The KFG may easily enable finding optimal buffer allocation by maximizing the usage of the limited buffer resources (i.e., on-chip buffer T1) without overwriting.

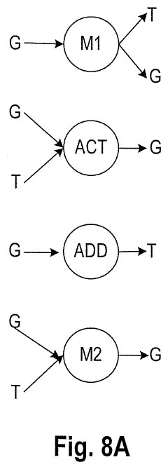

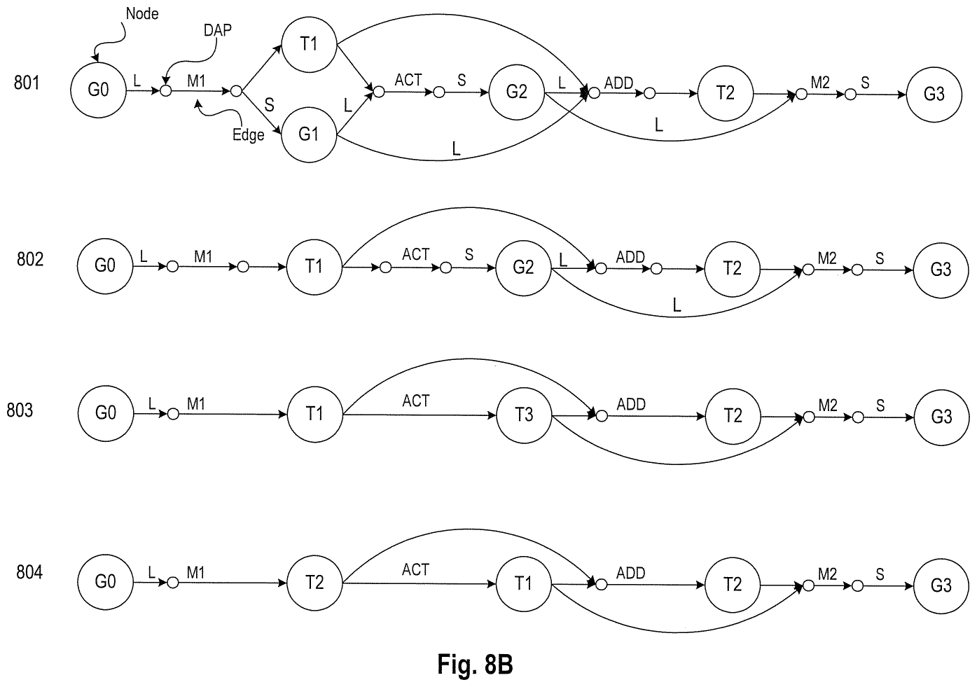

KFG according to embodiments of the present disclosure is also beneficial even when hardware design choices are already made such that some operation results should be stored or written to certain storages. Here, it is assumed that not every computation result can be stored in the on-chip storage in general hardware design. Reference is now made to FIG. 8A, which illustrates an example of the hardware design choices for the computation graph of FIG. 2. For a purpose of an illustration, it is assumed that the hardware accelerator such as the processing system 404 already made a design choice to assign input/output storages for each operation as shown in FIG. 8A. A first multiplication operation M1 takes two inputs from a global buffer (G) and its output can be stored either at a global buffer or on-chip buffer (T). An activation operation ACT takes an input from the global buffer or the on-chip buffer and its output is stored in a global buffer. As shown in FIG. 2, the activation node ACT depends on the first multiplication node M1, and thus the input buffer of the activation operation ACT matches the output buffer of the first multiplication operation M1. Similarly, an addition operation ADD takes an input from the global buffer and its output is stored in an on-chip buffer, and a second multiplication operation M2 takes inputs from a global buffer or an on-chip buffer and its output is stored in a global buffer.

FIG. 8B illustrates a third example for transforming the computation graph of FIG. 2 to determine whether the hardware design choices illustrated in FIG. 8A are desirable, consistent with embodiments of the present disclosure.

State 801 of FIG. 8B shows an initial state of KFG derived from the computation graph of FIG. 2 with the design choices illustrated in FIG. 8A. The KFG at the state 801 has the same properties with the KFG at the state 501 of FIG. 5 except that the KFG at the state 801 complies with the design choices already made according to FIG. 8A. The KFG at the state 801 also comprises DAPs and the storages are uniquely assigned to the nodes, as described referring to the state 501 of FIG. 5. The difference of FIG. 8B from FIG. 5 will be described in detail hereinafter.

At state 801, the output of a first multiplication operation M1 can be written to a global buffer G1 or on-chip buffer T1. DAP at the starting point of an addition edge ADD receives two inputs among which one input can be loaded from the global buffer G1 or on-chip buffer T1. That is, the KFG at state 801 includes two alternate paths for the one input, and thus the KFG at state 801 may be adjusted to eliminate the redundant path. The elimination of the redundant path may be performed by using a heuristic method. According to a dominance tree (DOM), the DAP at the starting point of the addition edge ADD is dominated by DAP at the ending point of the first multiplication edge M1. The reason that the DAP at the starting point of the addition edge ADD receives two copies from the on-chip buffer T1 and global buffer G1 is that the output of the first multiplication operation M1 can be stored at either of the on-chip buffer T1 and global buffer G1. Therefore, it is recognized that eliminating one of the two paths does not change the original computation graph's result.

It is noted from the adjusted KFG at state 802 of FIG. 8B that the lower path among the two alternate paths (i.e., path going through global buffer G1) is eliminated. This is because the lower path has longer latency than the upper path in the state 801. That is, the lower path has two heavy data transfers L and S while the upper path does not have those. Since the lower path has higher operation cost compared to the upper path, the lower path is removed in the state 802. The KFG at state 802 shows the adjusted KFG after pruning at least one of the alternate paths.

To determine whether the design choice is optimal, the processes continue to examine the adjusted KFG at state 802. It is noted from the KFG at state 802 that using a global buffer G2 becomes a bottleneck in the critical path of the graph since the global buffer G2 causes two heavy data transfers S and L during execution. If the global buffer G2 is replaced with an on-chip buffer (e.g., on-chip buffer T3) as shown in state 803, the execution time for the KFG will be decreased and the performance of the processing system executing the graph will be improved. The KFG at state 803 shows that the global buffer G2 is replaced with the on-chip buffer T3.

The processes continue to examine the KFG at state 803 to further determine whether the storage allocation is optimal. Three different on-chip buffers T1 to T3 are used at state 803. A question whether the three on-chip buffers are necessary for the best performance arises. The optimal buffer number and allocation can be obtained by replacing the on-chip buffer T3 with the on-chip buffer T1 for a third node and replacing the on-chip buffer T1 with the on-chip buffer T2 for a second node as shown in state 804 of FIG. 8B. This adjustment from the state 803 to state 804 may be justified by using the live range analysis on each data storage, as described regarding FIG. 5. According to some embodiments, the adjustment from the state 803 to state 804 can be performed by applying greedy-based graph coloring analysis to obtain optimal storage assignment. It is noted that only two on-chip buffers are needed to achieve the best performance. Through analysis based on KFG, it is noted that the design choices made in the example of FIG. 8A was not the best. Based on the analysis using KFG, it is possible to change the hardware design accordingly or the design choices for improving the performance.

Based on the foregoing, it is noted that KFG of the present disclosure provides an effective method to explore the design trade-off between the hardware resources and computation performance. The present disclosure introduces a new graph structure that enables efficiently mapping machine learning models onto hardware accelerators. Unlike conventional computation graphs used in machine learning where nodes represent operations and edges represent tensors flowing from one node to another, KFG includes nodes to represent data storages (on-chip or off-chip) and edges to represent operations transforming or processing data when flowing from one storage node to another storage node. Each node in KFG is explicitly and uniquely allocated to a logical storage based on Single Storage Allocation (SSA) when generating the KFG, and then the logical storage can be mapped to a physical storage and removed at some point in the optimization/transformation process. Therefore, optimization process or transformation process can be simplified. With KFG, it is also allowed to apply existing compiler technologies such as DOM and live range analysis to optimize the machine learning performance. KFG helps easily identifying the critical path and the optimal on-chip storage allocation for maximal performance. KFG may also help identifying the opportunities to pipeline data transfers and computations to further improve the performance. The analysis of the KFG assists with automatically revising the accelerator's design to more efficiently use the hardware resources. That is, it can be determined whether on-chip storages should be added or re-assigned. KFG also enables a general approach for versatile optimizations during hardware accelerator design exploration and performance improvement.

KFG can enable various optimizations on the computation graph, and can be applied with different types of devices, such as GPU, FPGA, and other ASIC (Application-Specific Integrated Circuit) accelerators. In case the hardware design is already fixed, KFG can still help by selectively enabling proper optimizations described herein. KFG has a lightweight overhead and linear complexity. KFG can be applied as a standalone optimization, or on top of other existing optimizations as desired.

Embodiments herein include database systems, methods, and tangible non-transitory computer-readable media. The methods may be executed, for example, by at least one processor that receives instructions from a tangible non-transitory computer-readable storage medium. Similarly, systems consistent with the present disclosure may include at least one processor and memory, and the memory may be a tangible non-transitory computer-readable storage medium. As used herein, a tangible non-transitory computer-readable storage medium refers to any type of physical memory on which information or data readable by at least one processor may be stored. Examples include random access memory (RAM), read-only memory (ROM), volatile memory, non-volatile memory, hard drives, CD ROMs, DVDs, flash drives, disks, and any other known physical storage medium. Singular terms, such as “memory” and “computer-readable storage medium,” may additionally refer to multiple structures, such a plurality of memories and/or computer-readable storage media. As referred to herein, a “memory” may comprise any type of computer-readable storage medium unless otherwise specified. A computer-readable storage medium may store instructions for execution by at least one processor, including instructions for causing the processor to perform steps or stages consistent with embodiments herein. Additionally, one or more computer-readable storage media may be utilized in implementing a computer-implemented method. The term “computer-readable storage medium” should be understood to include tangible items and exclude carrier waves and transient signals.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

1. An apparatus for transforming a computation graph, comprising:
a converter configured to convert the computation graph into a storage-based graph having a plurality of nodes and at least one edge representing an operation performed on data flowing between two nodes among the plurality of nodes, each of the plurality of nodes representing a data storage;
an optimizer configured to:
identify at least one processing condition of a processing system executing the computation graph; and
adjust the storage-based graph according to the at least one processing condition.

2. The apparatus of claim 1, wherein the storage-based graph includes at least one virtual node indicating data availability.

3. The apparatus of claim 1, wherein a plurality of storages are uniquely assigned to the plurality of nodes in the storage-based graph.

4. The apparatus of claim 3, wherein the plurality of storages are logical storages.

5. The apparatus of claim 3, wherein the optimizer is further configured to identify at least one global storage causing latency in a critical path of the storage-based graph, and
wherein the at least one global storage among the plurality of storages assigned to the plurality of nodes is replaced with at least one on-chip storage in the adjusted storage-based graph.

6. The apparatus of claim 4, wherein one on-chip storage is assigned to at least two nodes of the plurality of nodes in the adjusted storage-based graph.

7. The apparatus of claim 1, wherein at least one redundant path having longer latency than an alternate path is eliminated in the adjusted storage-based graph.

8. The apparatus of claim 1, wherein the optimizer is further configured to:
update the adjusted storage-based graph by associating each edge of the at least one edge with a corresponding operation cost.

9. The apparatus of claim 1, wherein the at least one processing condition is selected from a group consisting of available on-chip storage resources of the processing system and storage allocation information for a certain operation.

10. A method for transforming a computation graph, comprising:
converting the computation graph into a storage-based graph having a plurality of nodes and at least one edge representing an operation performed on data flowing between two nodes among the plurality of nodes, each of the plurality of nodes representing a data storage;
identifying at least one processing condition of a processing system executing the computation graph; and
adjusting the storage-based graph according to the at least one processing condition.

11. The method of claim 10, wherein the storage-based graph includes at least one virtual node indicating data availability.

12. The method of claim 10, wherein a plurality of storages are uniquely assigned to the plurality of nodes in the storage-based graph.

13. The method of claim 10, wherein the plurality of storages are logical storages.

14. The method of claim 12, further comprising identifying at least one global storage causing latency in a critical path of the storage-based graph, and
wherein the adjusting the storage-based graph according to the at least one processing condition comprises replacing the at least one global storage among the plurality of storages assigned to the plurality of nodes with at least one on-chip storage.

15. The method of claim 14, wherein one on-chip storage is assigned to at least two nodes of the plurality of nodes in the adjusted storage-based graph.

16. The method of claim 10, wherein the adjusting the storage-based graph according to the at least one processing condition comprises:
eliminating at least one redundant path having longer latency than an alternate path in the storage-based graph.

17. The method of claim 10, further comprising updating the adjusted storage-based graph by associating each edge of the at least one edge with a corresponding operation cost.

18. The method of claim 10, wherein the at least one processing condition is selected from a group consisting of available on-chip storage resources of the processing system and storage allocation information for a certain operation.

19. A non-transitory computer readable medium that stores a set of instructions that is executable by at least one processor of a computing device to cause the computing device to perform a method for transforming a computation graph, the method comprising:
converting the computation graph into a storage-based graph having a plurality of nodes and at least one edge representing an operation performed on data flowing between two nodes among the plurality of nodes, each of the plurality of nodes representing a data storage;
identifying at least one processing condition of a processing system executing the computation graph; and
adjusting the storage-based graph according to the at least one processing condition.

20. The computer readable medium of claim 19, wherein the storage-based graph includes at least one virtual node indicating data availability.

21. The computer readable medium of claim 19, wherein a plurality of storages are uniquely assigned to the plurality of nodes in the storage-based graph.

22. The computer readable medium of claim 19, wherein the plurality of storages are logical storages.

23. The computer readable medium of claim 21, wherein the set of instructions that is executable by at least one processor of the computing device to cause the computing device to further perform:
identifying at least one global storage causing latency in a critical path of the storage-based graph, and
wherein the adjusting the storage-based graph according to the at least one processing condition comprises replacing the at least one global storage among the plurality of storages assigned to the plurality of nodes with at least one on-chip storage.

24. The computer readable medium of claim 23, wherein one on-chip storage is assigned to at least two nodes of the plurality of nodes in the adjusted storage-based graph.

25. The computer readable medium of claim 19, wherein adjusting the storage-based graph according to the at least one processing condition comprises:
eliminating at least one redundant path having longer latency than an alternate path in the storage-based graph.

26. The computer readable medium of claim 19, wherein the set of instructions that is executable by at least one processor of the computing device to cause the computing device to further perform:
updating the adjusted storage-based graph by associating each edge of the at least one edge with a corresponding computation cost.

27. The computer readable medium of claim 19, wherein the at least one processing condition is selected from a group consisting of available on-chip storage resources of the processing system and storage allocation information for a certain operation.
